(19) United States
(12) Patent Application Publication
(10) Pub. No.: US 2015/0101367 A1
(43) Pub. Date: Apr. 16, 2015

(54) TECHNIQUE FOR MANUFACTURING GLASS TUBE CASE OF ELECTRODELESS LAMP

(71) Applicants: Guozhen Tan, JiangmenCity (CN); Wenfeng He, JiangmenCity (CN)

(72) Inventors: Guozhen Tan, JiangmenCity (CN); Wenfeng He, JiangmenCity (CN)

(73) Assignee: GUANGDONG ELX LIGHTING TECHNOLOGY CO., LTD., Jiangmen, Guangdong Province (CN)

(21) Appl. No.: 14/403,192

(22) PCT Filed: May 23, 2012
(86) PCT No.: PCT/CN2012/075959

§ 371 Date: Nov. 23, 2014

(51) Int. Cl. C03B 23/13; C03B 25/02; H01J 9/24; C03C 17/00; C03C 23/00; C03B 32/00; C03C 17/34

(52) U.S. Cl. CPC C03B 23/13; C03B 32/00; C03B 25/02; C03C 17/34; C03C 17/004; C03C 23/0075; H01J 9/247; C03C 2217/70; C03C 2218/114; C03C 2218/322; C03C 2218/31
USPC 65/41

(57) ABSTRACT

The present invention provides a process for manufacturing glass tube shell of electrodeless lamp, which comprises seven steps: washing, coating, bepowdering, wiping off, abutting and annealing, wherein the coating step introduced in the present invention is primarily for increasing the evenness and densification degree of the inner wall of the glass tube, so as to guarantee the adhesion homogeneity of the step of bepowdering; besides, the present invention uses multi-step temperature controlling process for steps of coating, bepowdering and baking to effectively guarantee the coating thickness, and increase the productivity by 50%, in addition, a fan is introduced to align to the entrance of the glass tube when baking the powder, so as to increase the entrance of oxygen, and improve the baking efficiency, at last, high temperature annealing is performed to the joint to eliminate the stress after abutting.

### TECHNICAL FIELD

The present invention relates to a process for manufacturing glass tube shell, in particular to a process for manufacturing glass tube shell of electrodeless lamp.

### BACKGROUND OF THE INVENTION

As a lighting product without filament and electrode, electrodeless lamp is short for electrodeless gas discharging fluorescent lamp, whose working principle is to produce plasmas through the avalanche ionization of the gas inside the lamp by coupling the electromagnetic field derived from high frequency generator thereinto in a manner of induction. The excited plasmas atoms radiate ultraviolet rays when they come bake to the stationary state. Upon being excited by the ultraviolet rays, the fluorescent powder in the inner wall of the lamp generates visible light.

At present, the process for manufacturing glass tube shell of electrodeless lamp generally includes washing the glass tubes at first, and then followed with bepowdering, baking powder, wiping off the powder and joint abutting. However, the glass tube shell of electrodeless lamp manufactured according to said process has great deficiencies in luminous efficiency, luminance decrease and the lifespan, and fails to meet people's demand.

### SUMMARY OF THE INVENTION

In order to solve the above problems, the object of the present invention is to provide a process for manufacturing glass tube shell of electrodeless lamp to improve the performance of the electrodeless lamp in luminous efficiency, luminance decrease and the lifespan.

The technical solution adopted by the present invention to solve the technical problem is:
a process for manufacturing the glass tube shell of electrodeless lamp, comprising:
1) washing the tube: soaking the glass tube in the acidic solution, then soaking it again in purified water after taking out and washing, then taking out and drying, and finally cooling to room temperature naturally;
2) coating film: pouring the membrane solution which is aluminium oxide solution with a concentration of 12% into the glass tube, after the homogenous adhesion of the membrane solution to the inner wall of the glass tube, drying the tube in a dryer, and finally wiping off the film layer at the edges of both ends of the glass tube;
3) bepowdering: pouring a fluorescent slurry with a viscosity of 30 Pa·s and a proportion of 1.5 into the glass tube; after the homogenous adhesion of the fluorescent slurry to the inner wall of the glass tube, drying the tube in a dryer, and finally wiping off the powder layer at the edges of both ends of the glass tube;
4) baking powder: disposing the glass tube in the baking machine with the entrance of the glass tube aligning to the entrance of the ventilation tube, turning on the heating switch and fan to perform baking, and then cooling to room temperature naturally after baking;
5) wiping off the powder: wiping off the fluorescent powder inside and outside the ends of the glass tube as well as inside the exhaust pipe, then shaking off the residue powder and foreign body inside the tube;
6) abutting: preheating the matched glass tube with a deputy firearm at a temperature of 600° C.˜800° C. for 3˜5 seconds, then sintering with a main firearm at a temperature of 900° C.˜1100° C., after finishing sintering, performing a preliminary annealingwith the deputy firearm for 5˜10 seconds again;
7) annealing: disposing the sintered tube shell in the dryer to perform the high temperature annealing to eliminate the stress.

The beneficial effects of the present invention are: prior to the bepowdering step, a coating step is added primarily for increasing the evenness and densification degree of the inner wall of the glass tube, so as to guarantee the adhesion homogeneity of the step of bepowdering; besides, the present invention uses multi-step temperature controlling process for steps of coating, bepowdering and baking to effectively guarantee the coating thickness, as a result, the productivity increases by 50%. Furthermore, a fan is introduced to align to the entrance of the glass tube in the baking step, so as to increase the entrance of oxygen and improve the baking efficiency. At last, in the present invention, high temperature annealing is performed to the joint to eliminate the stress after abutting. Based on the summarization of the aforesaid factors, the present invention is effectively beneficial in improving the performance of the electrodeless lamp in luminous efficiency, luminance decrease and the lifespan.

### DETAILED DESCRIPTION OF EMBODIMENTS

A process for manufacturing the glass tube shell of electrodeless lamp, comprising:
1) washing the tube: soaking the glass tube in the acidic solution, then soaking it again in purified water after taking out and washing, then taking out and drying, and finally cooling to room temperature naturally;
the specific operations are as follows: at first, soaking the glass tube fully in the acidic solution which is a hydrofluoric acid with a pH value of 7˜8 in a ratio with water of 1:80 for 2˜3 mins; then, soaking it again in purified water having an electrically conductivity of less than 6 us/cm for 2˜3 mins after taking out and washing, so as to completely remove the residue acidic solution; finally disposing the clean glass tube in the dryer to be baked at a drying temperature of up to 70° C. within 5 mins, keeping the temperature for 10 mins, and cooling to room temperature naturally and then beginning the next step. This step primarily aims to clear the glass tube to guarantee the dryness and the neatness without any impurity residue on the inner wall of the glass tube;
2) coating film: pouring the membrane solution which is aluminium oxide solution with a concentration of 12% into the glass tube, after the homogenous adhesion of the membrane solution to the inner wall of the glass tube, drying the tube in a dryer, and finally wiping off the film layer at the edges of both ends of the glass tube;
the specific operations are as follows: filtering the membrane solution by using a double 100 mesh sieve for preparing to use; pouring the membrane solution into the glass tube; when the portion to be coated inside the glass tube is adhered to the membrane solution, placing the glass tube upside down to homogeneously adhere the membrane layer to the inner wall of the glass tube; then, drying the glass tube with coated film in a dryer, wherein the dryer is a tunnel oven which is internally divided into four portions with temperatures of 190° C., 200° C., 180° C. and 190° C. respectively, and periods the products stay in each portion are 5 mins, 5 mins, 7 mins and 7 mins respectively; after finishing drying, wiping off the film layer at the edges of both ends of the glass tube and then beginning the next step. This step primary aims to improve the evenness and densification degree of the inner wall of the glass tube, so as to guarantee the adhesion homogeneity of the step of be powdering;
3) bepowdering: pouring a fluorescent slurry with a viscosity of 30Pa·s and a proportion of 1.5 into the glass tube; after the homogenous adhesion of the fluorescent slurry to the inner wall of the glass tube, drying the tube in a dryer, and finally wiping off the powder layer at the edges of both ends of the glass tube; the specific operations are as follows: preparing a fluorescent slurry, and pouring it into the glass tube; when the portion to be coated inside the glass tube is adhered to the fluorescent slurry, placing the glass tube upside down to homogeneously adhere the fluorescent slurry to the inner wall of the glass tube; then, drying the glass tube with coated the fluorescent slurry in a dryer, wherein the dryer is a tunnel oven which is internally divided into four portions with temperatures of 190° C., 200° C., 180° C. and 190° C. respectively, and periods the products stay in each portion are 15 mins, 15 mins, 27 mins and 27 mins respectively; after finishing drying, wiping off the powder layer at the edges of both ends of the glass tube and then beginning the next step.
4) baking powder: disposing the glass tube in the baking machine with the entrance of the glass tube aligning to the entrance of the ventilation tube, turning on the heating switch and fan to perform baking, and then cooling to room temperature naturally after baking;
the specific operations are as follows: disposing the glass tube in the baking machine with the entrance of the glass tube aligning to the entrance of the ventilation tube; turning on the heating switch, and performing an average three-phases temperature increase, wherein each temperature increase period is 10 mins, and keeping the temperature therebetween for 3 mins, when the temperature reaches 680° C.; turning on the fan, further performing an average three-phases temperature increase, wherein each temperature increase period is 10 mins, and keeping the temperature therebetween for 3 mins, when temperature reaches 750° C., keeping the temperature for 60 mins; after finishing keeping the temperature, turning off the heating switch and the fan, cooling to room temperature naturally and then beginning the next step. This step primarily aims to remove the impurities in the fluorescent powder by high temperature oxidation and using the fan.
5) wiping off the powder: wiping off the fluorescent powder inside and outside the ends of the glass tube as well as inside the exhaust pipe, then shaking off the residue powder and foreign body inside the tube;
the specific operations are as follows: wiping off the fluorescent powder inside and outside the ends of the glass tube with the gauze, wherein the length of wiping varies in the types of the tubes: 40 W: 5˜6 mm, 80 W˜150 W: 7˜8 mm, 200 W˜300 W: 8˜10 mm; then wiping off the fluorescent powder in the exhaust pipe by using thin iron wire with cotton ball; subsequently shaking off the residue powder particles and foreign body inside the tube; and then beginning the next step.
6) abutting: preheating the matched glass tube with a deputy firearm at a temperature of 600° C.˜800° C. for 3˜5 seconds, wherein the preferable temperature is 900° C.; then sintering with a main firearm at a temperature of 900° C.˜1100° C., wherein the preferable temperature is 1000° C.; after finishing sintering, performing a preliminary annealingwith the deputy firearm for 5˜10 seconds;
this step primarily aims to seal the two pieces of the lamp tube into a tube shell, and then to perform preliminary annealing to eliminate the stress.
7) annealing: disposing the sintered tube shell in the dryer to perform the high temperature annealing to eliminate the stress.
The dryer used in this step is a tunnel oven, which is internally divided into three portions with temperatures of 500° C. in the first portion, 780° C. in the second portion, and 700° C. in the third portion respectively, and periods the products stay in each portion are all 10 mins.

In the present invention, prior to the bepowdering step, a coating step is added primarily for increasing the evenness and densification degree of the inner wall of the glass tubes, so as to guarantee the adhesion homogeneity of the step of bepowdering; besides, the invention uses multi-step temperature controlling process for steps of coating, bepowdering and baking to effectively guarantee the coating thickness. As a result, the productivity increases by 50%. Furthermore, a fan is introduced to align to the entrance of the glass tube when baking the powder, so as to increase the entrance of oxygen and improve the baking efficiency. At last, in the present invention, high temperature annealing is performed to the joint to eliminate the stress after abutting. Based on the summarization of the aforesaid factors, the present invention is effectively beneficial in improving the performance of the electrodeless lamp in luminous efficiency, luminance decrease and the lifespan.

What is claimed is:

1. A process for manufacturing a glass tube shell of an electrodeless lamp, wherein the process comprises the following steps:
1) tube washing: soaking a glass tube in an acidic solution, then taking it out and washing it before soaking it in purified water, then taking it out and drying it, and finally cooling it down to room temperature naturally;
2) film coating: pouring a membrane solution which is an aluminium oxide solution with a concentration of 12% into the glass tube, after homogenous adhesion of the membrane solution to the inner wall of the glass tube, drying the glass tube in a dryer, and finally wiping off the film layer at edges of both ends of the glass tube;
3) bepowdering: pouring a fluorescent slurry with a viscosity of 30 Pa·s and a proportion of 1.5 into the glass tube; after homogenous adhesion of the fluorescent slurry to the inner wall of the glass tube, drying the glass tube in a dryer, and finally wiping off the powder layer at edges of both ends of the glass tube;
4) powder baking: disposing the glass tube in a baking machine with opening of the glass tube aligning to an entrance of a ventilation tube, turning on a heating switch and a fan to perform baking, and then cooling the glass tube down to room temperature after baking;
5) wiping off the powder: wiping off fluorescent powder inside and outside ends of the glass tube as well as inside the exhaust pipe, then shaking off the residue powder and foreign body inside the glass tube;
6) abutting: preheating a matched glass tube with a deputy firearm at a temperature of 600° C.˜800° C. for 3˜5 seconds, then sintering with a main firearm at a temperature of 900° C.˜1100° C., after finishing sintering, performing a preliminary annealing with the deputy firearm for 5˜10 seconds again;
7) annealing: disposing the sintered tube shell in the dryer to perform high temperature annealing to eliminate stress.

2. The process for manufacturing the glass tube shell of an electrodeless lamp according to claim 1, wherein the acidic solution in step 1) is hydrofluoric acid solution, and the ratio between hydrofluoric acid and water is 1:80.

3. The process for manufacturing the glass tube shell of an electrodeless lamp according to claim 1, wherein the purified water used in step 1) has an electrically conductivity of less than 6 us/cm and the glass tube is soaked therein for 2˜3 minutes.

4. The process for manufacturing the glass tube shell of an electrodeless lamp according to claim 1, wherein the drying temperature in step 1) rises up to 70° C. within 5 minutes, and then the temperature is kept for 10 minutes.

5. The process for manufacturing the glass tube shell of an electrodeless lamp according to claim 1, wherein the membrane solution used in step 2) is filtered by a double 100 mesh sieve.

6. The process for manufacturing the glass tube shell of an electrodeless lamp according to claim 1, wherein the dryer used in step 2) is a tunnel oven, which is internally divided into four portions with temperatures of 190° C., 200° C., 180° C. and 190° C. respectively, and the glass tube stays in each portion for 5 minutes, 5 minutes, 7 minutes and 7 minutes, respectively.

7. The process for manufacturing the glass tube shell of an electrodeless lamp according to claim 1, wherein the dryer used in step 3) is a tunnel oven, which is internally divided into four portions with temperatures of 190° C., 200° C., 180° C. and 190° C. respectively, and the glass tube stays in each portion for 15 minutes, 15 minutes, 27 minutes and 27 minutes, respectively.

8. The process for manufacturing the glass tube shell of an electrodeless lamp according to claim 1, wherein the baking step in step 4) comprises: turning on the heating switch; when the temperature increases to 680° C., turning on the fan; when temperature increases to 750° C., keeping the temperature for 60 minutes; and after finishing keeping the temperature, turning off the heating switch and the fan.

9. The process for manufacturing the glass tube shell of an electrodeless lamp according to claim 1, wherein the dryer in used step 7) is a tunnel oven, which is internally divided into three portions with temperatures of 500° C. in the first portion, 780° C. in the second portion, and 700° C. in the third portion respectively, and the glass tube stays in each portion for 10 minutes.
